(19) United States
(12) Patent Application Publication
(10) Pub. No.: US 2006/0234750 A1
(43) Pub. Date: Oct. 19, 2006

(54) Method and apparatus for quantization and detection of power loadings in MIMO beamforming systems

(75) Inventors: Jyhchau (Henry) Horng, Saratoga, CA (US); Chiu Ngo, San Francisco, CA (US)

Correspondence Address: Kenneth L. Sherman, Esq.;Myers Dawes Andras & Sherman, LLP, 11TH Floor, 19900 MacArthur Blvd., Irvine, CA, 92612, US

(73) Assignee: Samsung Electronics Co., Ltd., Suwon City (KR)

(21) Appl. No.: 11/110,337

(22) Filed: Apr. 19, 2005

(51) Int. Cl. H04B 7/00; H04B 1/00; H04Q 7/20

(52) U.S. Cl. 455/522; 455/70

(57) ABSTRACT

A telecommunication system has a wireless transmitter that transmits data stream signals via multiple channels over a plurality of antennas, the transmitter having a power controller that selects transmission power loading per channel. The telecommunication system further has a wireless receiver that receives data stream signals from the transmitter, and the receiver has a detector that estimates power loading selections of the transmitter. The controller further quantizes the power loading values, and the detector uses the quantized power loading values to automatically estimate power loading selection by the transmitter.

### FIELD OF THE INVENTION

The present invention relates generally to data communication, and more particularly, to data communication in multi-channel communication system such as multiple-input multiple-output (MIMO) systems.

### BACKGROUND OF THE INVENTION

A multiple-input-multiple-output (MIMO) communication system employs multiple transmit antennas in a transmitter and multiple receive antennas in a receiver for data transmission. A MIMO channel formed by the transmit and receive antennas may be decomposed into independent channels, wherein each channel is a spatial sub-channel (or a transmission channel) of the MIMO channel and corresponds to a dimension. The MIMO system can provide improved performance (e.g., increased transmission capacity) if the additional dimensionalities created by the multiple transmit and receive antennas are utilized.

There are two types of MIMO systems, open-loop and closed-loop techniques. In an open-loop system, the MIMO transmitter has no prior knowledge of the channel condition and therefore, space-time coding techniques are usually implemented in the transmitter to combat fading channels. On the other hand, in a closed-loop system, the channel state information (CSI) can be fed back to transmitter from the receiver. Thus, some pre-processing based on the channel state information can be performed at the transmitter to simplify the receiver design and achieve better performance. Such techniques are referred as beamforming techniques, which provide better performance gains in desired receiver's direction and suppress the transmit power in other directions.

In a beamforming system, the power loading for each data stream plays an important role in determining the system performance and capacity. In order to maximize the system capacity, a conventional method for calculating transmitted power is known as the “water filling” algorithm, described in D.-S. Shiu, G. J. Fochini, M. J. Gans, and J. M. Kahn, “Fading correlation and its effect on the capacity of multi-element antenna systems”, IEEE Trans. Communication, vol. 48, pp. 502-513, March 2000, incorporated herein by reference. For a known channel, optimum power distribution using the “water-filling” technique can be utilized, wherein the “water-filling” algorithm can be derived after converting the MIMO channel into a set of parallel channels using a singular value decomposition (SVD) of the channel matrix.

The “water falling” method assumes that system capacity is continuous. In practice, however, system capacity is quantized because only a finite number of data transmission rates can be supported in a communication system. Further, the total transmit power from the transmitter is fixed to a certain level due to government regulations. Therefore, the “water falling” method unduly limits implementation of power loading in a MIMO beamforming system.

### BRIEF SUMMARY OF THE INVENTION

The present invention addresses the above shortcomings. In one embodiment, the present invention provides a quantization method in a transmitter for uneven power loading weights with power sum constraint in a beamforming MIMO system. Such a quantization method achieves essentially maximum system capacity. The present invention further provides a method for detecting such quantized power loading weights at a receiver.

As such, in one embodiment the present invention provides a telecommunication system, comprising: a wireless transmitter that transmits data stream signals via multiple channels over a plurality of antennas, the transmitter including a power controller that selects transmission power loading per channel; and a wireless receiver that receives data stream signals from the transmitter, wherein the receiver comprises a detector that automatically estimates power loading selections of the transmitter.

The controller further quantizes the power loading values and the detector uses the quantized power loading values to estimate power loading selection by the transmitter. The controller selects the power loading values and further quantizes the power loading values under a power sum constraint.

In another version, the transmitter transmits a pilot signal with known power to the receiver, such that the detector estimates the transmit power loadings as a function of the power of the pilot signal and the quantized power loadings.

By using the quantized values for the optimal power loading weights, the memory size for fixed length representation is reduced, i.e., the overhead size in the signaling field is reduced in notifying the receiver. Further, when automatic detection is performed, using quantized values can significantly decrease the detection errors of the power loading weights at the receiver.

These and other features, aspects and advantages of the present invention will become understood with reference to the following description, appended claims and accompanying figures.

### BRIEF DESCRIPTION OF THE DRAWINGS

FIG. 1 shows a block diagram of an SVD-type MIMO beamforming system with transmitter power loading according to an embodiment of the present invention.

FIG. 2 shows a functional block diagram of another MIMO beamforming system according to another embodiment of the present invention.

FIG. 3 shows a flow chart of steps of an embodiment of quantization of power loading according to the present invention for a MIMO beamforming system.

FIG. 4 shows a flow chart of steps of an embodiment of automatic detection process of power loading according to the present invention for a MIMO beamforming system.

### DETAILED DESCRIPTION OF THE INVENTION

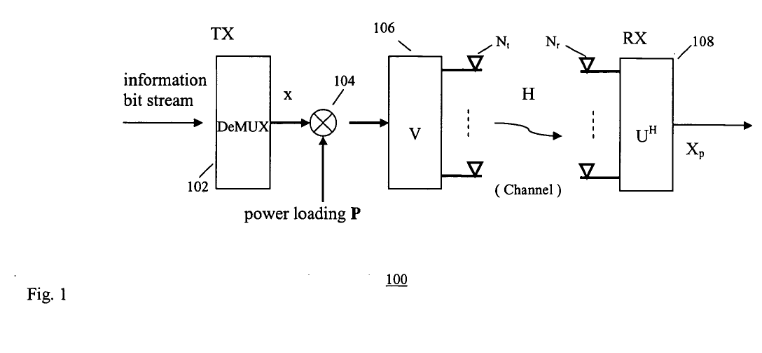

In a MIMO system, transmission power has to be properly distributed over the antennas to maximize the system capacity. For an unknown channel, uniform power distribution over the antennas can be applied. Referring to the example function block diagram in FIG. 1, a SVD-type MIMO system 100 includes a transmitter TX and a receiver RX, providing a beamforming technique used in closed-loop MIMO systems. Using SVD, a MIMO channel can be decomposed into several independent channels for data transmission, and therefore, there are no interferences between different data streams at the receiver.

In the MIMO system 100 of FIG. 1, for the MIMO channel H with Nₜ transmit antennas and Nᵣ receiving antennas, the received signal y can be represented as:
y=HPx+n (1)

where x is the Nₜ×1 transmitted signal vector, P is a diagonal matrix with loading power αᵢ along the diagonal, and n is the additive noise in the channel.

The channel H is a Nᵣ×Nₜ matrix where its element hᵢⱼ is the channel response from j^{th} transmit antenna to i^{th} receiving antenna. By applying SVD to H, H can be expressed as:
H=U D V^{H} (2)
where U and V are unitary matrices (i.e., U is a Nᵣ×Nₛₛ matrix where Nₛₛ is the number of data stream, and V^{H} is a Nₛₛ×Nₜ matrix) and D is a diagonal matrix with elements equal to the square-root of eigenvalues of the matrix (HH^{H}), where (·)^{H} is the Hermitian operation.

The example MIMO system 100 in FIG. 1 implements methods of quantized power loading at the transmitter TX, and automatic detection of power loading at the receiver, according to the present invention. In the MIMO system 100 of FIG. 1, DeMUX processing 102 splits the information bits into several streams, wherein each stream is provided to a different transmit antenna. A Combiner 104 multiplies the data stream output vector x of the DeMux 102 and power loadings P. Then, V processing 106 multiplies the input data vector by the matrix V at the transmitter TX, wherein relation (1) can be represented as:
y=HVPx+n (3)

Then U^{H} processing 108 in the receiver RX multiplies the received data vector by the matrix U^{H}, wherein the received signal after processing, Xₚ, can be expressed as:
Xₚ=U^{H}y=DPx+U^{H}n (4)

wherein the transmitted data x can be completely separated after this operation because D and P are diagonal matrices.

It can be shown in that the capacity C for such a MIMO system can be expressed as:

$$C = {\sum }_{i = 1}^{{N}_{t}} log ( 1 + \frac{{λ}_{i} {p}_{i}^{2}}{{N}_{0}} ) \qquad ( 5 )$$

where λᵢ and pᵢ² are the eigenvalue and transmitted power corresponding to the decomposed channels and N₀ is the noise power. From relation (5), it is observed that the transmitted power plays an important role in determining the system capacity as other parameters, λᵢ and N₀, are related to channel condition and can not be controlled.

In order to maximize the system capacity, the conventional “water filling” algorithm has often been used to calculate the transmitted power. Under the assumption that total transmitted power is fixed, wherein:

$${\sum }_{i = 1}^{{N}_{t}} {p}_{i}^{2} = {P}_{total} \qquad ( 6 )$$

where Pₜₒₜₐₗ is a fixed number for total transmitted power, and the optimal power for maximum capacity is expressed by:

$${p}_{i}^{2} = ( δ - \frac{{N}_{0}}{{λ}_{i}} ) \qquad ( 7 )$$

where δ is the “water level”.

In general, the capacity in relation (5) is a continuous capacity. As noted, in practice however, the system capacity, is a quantized one because only a finite number of data transmission rates can be supported in a communication system. Further, the total transmit power from the transmitter is fixed to a certain level due to government regulations. Therefore, there are some constraints and limitations in implementing the “water filling” algorithm for power loading in a MIMO beamforming system. Furthermore, the power loading information is necessary for a receiver to detect the transmitted signals correctly. The mechanism to eliminate the parameter mismatch between the transmitter and receiver is an important factor for the system performance.

Quantized Power Loading

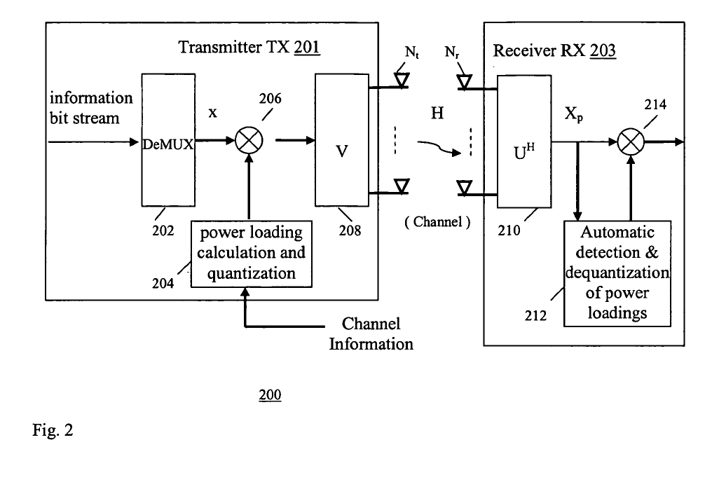

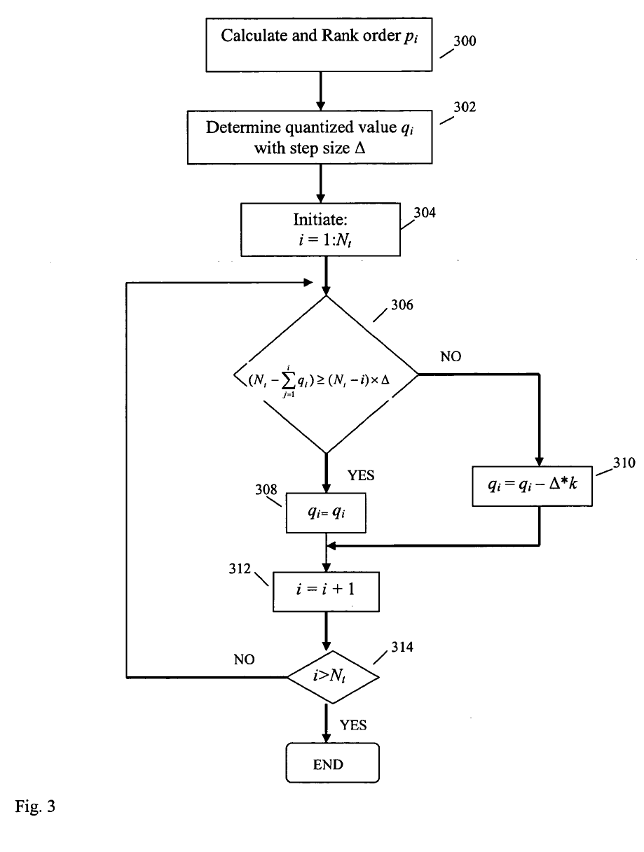

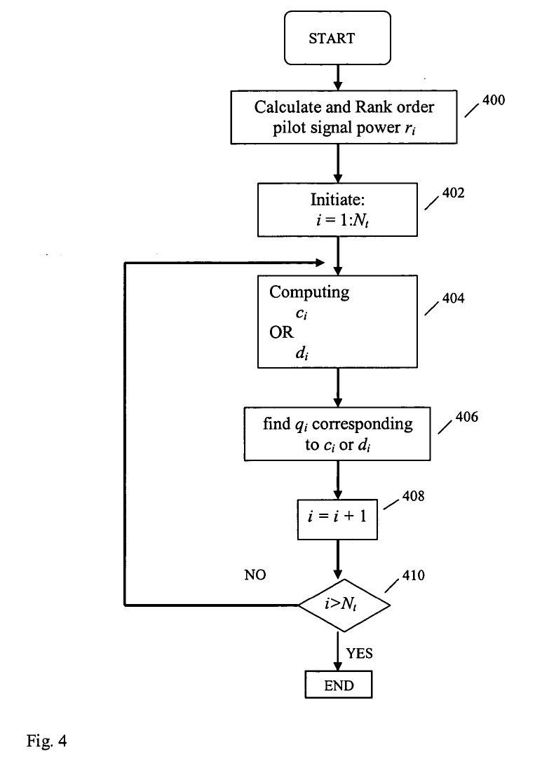

FIG. 2 shows an example functional block diagram of a MIMO beamforming system 200 which implements methods of quantized power loading (e.g., FIG. 3) in the transmitter, and automatic detection/estimation of power loading (e.g., FIG. 4) in the receiver, according to another embodiment of the present invention. The MIMO system 200 in FIG. 2 comprises a transmitter (TX) 201 including a DeMUX function 202, a Power Loading Calculation and Quantization function 204 (e.g., implementing steps of FIG. 3), a Combiner 206, and a V Processing function 208. The DeMUX 202 splits the information bits into Nₛₛ streams. Based on the channel information, the Quantization function 204 calculates and quantizes the power loading values for each stream (e.g., implementing steps of FIG. 3). The combiner 206 further multiplies the incoming data by the quantized power loadings to generate the input to V processing function 208 that multiples that input by the matrix V to generate the output.

The MIMO system 200 further comprises a receiver (RX) 203 including a U^{H} Processing function 210, an Automatic Detection and Dequantization Processing function 212 (e.g., implementing steps of FIG. 4), and a Combiner 214. The received signal is first multiplied by the U^{H} matrix in the Processing function 210 to generate the output Xₚ. Based on Xₚ, the Dequantization Processing function detects and de-quantizes the power loading values, p, that are used at the transmitter, and outputs the inverse values of the estimated power loading, P⁻¹ The combiner 214 multiplies Xₚ with p⁻¹.

According to an embodiment of the present invention, the transmission rate is selected based on channel measurements. Because the number of the supported data rates is a finite number, according to the present invention a set of quantized values qᵢ are used to represent un-quantized power loading value αᵢ with a power sum constraint as in relation (8) below: N,

$${\sum }_{i = 1}^{{N}_{t}} {α}_{i}^{2} = {N}_{t} \qquad ( 8 )$$

where

$${α}_{i}^{2} = \frac{{P}_{i}^{2}}{{P}_{data}} \qquad ( 9 )$$

wherein the power for each data stream, P_{data}, is assumed to be identical.

A primary reason to use quantized values for power loadings is that the receiver 203 requires knowledge of the power loading values (weights) αᵢ used by the transmitter 201 in order to detect the transmitted signals correctly. This can be done by either a first approach which involves sending power loading weights αᵢ to the receiver 203 through the signaling channels, or by a second approach which involves the receiver automatically detecting and calculating power loading based on received reference signals, such as pilot signals, according to the present invention.

In the first approach above, using quantized values qᵢ can reduce the memory size for fixed length representation, i.e., reduce the overhead size in the signaling field. In the second approach, using quantized values qᵢ significantly decreases power loading detection errors at the receiver 203. This is because generally received reference signals are corrupted by random noise, which introduce detection errors for continuous power loading values, no matter what the noise power is. Using quantized values qᵢ according to the present invention, detection error is smaller and occurs essentially when noise with sufficiently large power is present.

In one example, for a rank ordered set of power loading values αᵢ, where α₁≧α₂≧ . . . ≧α_{Nt}, we have:

$${N}_{t} > {α}_{1}^{2} > 0 ; and {N}_{t} - {\sum }_{j = 1}^{i - 1} {α}_{j}^{2} > {α}_{i}^{2} > 0 , i > 1 \qquad ( 10 )$$

wherein the range for αᵢ² increases as the value of Nₜ increases. Therefore, if uniform quantization with fixed step size is used, the number of quantized levels increases as Nₜ increases. In general, the higher the number of quantized levels, the better the performance, i.e., it depends on the quantization step size Δ. On the other hand, the principal terms (channels) with largest eigenvalues in relation (5) contribute most portions of the total capacity. Thus, the quantized level for the most energetic power loading qᵢ should be as large as possible to approach the un-quantized value αᵢ, while satisfying the power sum constraint in relation (8).

In order to satisfy the condition in relation (8), for a fixed step size Δ, the quantized value qᵢ corresponding to the power loading αᵢ², can be determined by the following example quantization procedure:

(i) calculate and rank order αᵢ based on relations (5) and (9).

(ii) determine quantized value qᵢ corresponding to power loading αᵢ².

(iii) starting from i=1,
Rᵢ represents residual power for the sum of the selected power qⱼ, j=1, . . . , i, wherein:

$$if {R}_{i} = ( {N}_{t} - {\sum }_{j = 1}^{i} {q}_{j} ) \geq ( {N}_{t} - i ) \times Δ \qquad ( 11 )$$
then qᵢ=qᵢ;
otherwise, qᵢ=qᵢ−Δ*k
   where k is the smallest integer to satisfy relation (11). Because qᵢ is greater or equal to Δ, the residual power has to be equal or greater than (Nₜ−i)×Δ, the value of qᵢ is reduced until relation (11) holds.

(iv) for i=i+1, repeat step (iii) until i>Nₜ.

FIG. 3 shows a flowchart of the steps of an example process implementing the above quantization procedure. The quantization process involves: calculating pᵢ according to relation (7) and rank-ordering the pᵢ (step 300); determining qᵢ corresponding to power loading αᵢ², with step size Δ (step 302); initiating the index i as i=1:Nₜ (step 304); determining if the relation

$$( {N}_{t} - {\sum }_{j = 1}^{i} {q}_{i} ) \geq ( {N}_{t} - i ) \times Δ$$

is true (step 306), and if so, in step 308 setting qᵢ=qᵢ (if the relation

$$( {N}_{t} - {\sum }_{j = 1}^{i} {q}_{i} ) \geq ( {N}_{t} - i ) \times Δ$$

is true, the residual power is large enough for assigning the remaining power loadings; otherwise, the current assigned value has to be reduced as shown in step 310 below), otherwise, setting qᵢ=qᵢ−Δ*k (step 310); incrementing i by one (step 312); determining if i>Nₜ (step 214), and if so ending the process, otherwise proceeding to previous step 306.

In another embodiment, instead of calculating power loadings based on relation (7), alternative methods of calculating power loadings, such as the example reverse power loading method described in commonly assigned patent application, titled: “Power Loading Method and Apparatus for Throughput Enhancement in MIMO systems”, attorney docket SAM2B.PAU.17 (incorporated herein by reference), can be used.

Example Quantization

A numerical example quantization according to the present invention is now described. Consider a set of quantized power loading values qᵢ with Nₜ=4 and Δ=0.2, where q₁=2.2, q₂=1.6, q₃=0.4, and q₄=0.2.

In order to satisfy the condition in relation (8), qᵢ is adjusted as follows:
(1) with i=1, the value R₁=1.8≧0.6 in relation (11), then q₁=2.2.
(2) with i=2, the value R₂=0.2<0.4, then q₂=1.6−0.2=1.4, and k=1.
(3) with i=3, the value R₃=0<0.2, then q₃=0.4−0.2=0.2, and k=1.
(4) with i=4, the value R₄=0.2≧0.2 in relation (11), then q₄=0.2.

The final result for qᵢ=[2.2, 1.4, 0.2, 0.2], which satisfies the condition in relation (8).

Automatic Power Loading Detection

In accordance with another aspect of the present invention, in order to process the received signal correctly, the receiver 203 is provided with a mechanism to detect the power loading used at the transmitter 201. In one embodiment, by detecting the power loading of received reference signals with known power, such as pilot signals, the power loading can be effectively computed by the receiver 203. Recalling relation (4), and after separation operation in processing function 210 in the receiver 203, letting rᵢ represent the power for received pilot signals for the i^{th} data stream, then rᵢ can be expressed as:
rᵢ=αᵢ²λᵢS²+N₀ (12)

where S² is the transmitted pilot power. It should be noted that the power sum constraint in relation (8) still holds. Therefore, estimation (calculation) of αᵢ at the receiver 203 can be performed by computing the ratio or the difference of various rᵢ as:

ratio:

$$\frac{{r}_{i}}{{r}_{j}} = \frac{{α}_{i}^{2} {λ}_{i} {S}^{2} + {N}_{0}}{{α}_{j}^{2} {λ}_{j} {S}^{2} + {N}_{0}} \approx \frac{{α}_{i}^{2} {λ}_{i}}{{α}_{j}^{2} {λ}_{j}} \qquad ( 13 a )$$

difference: rᵢ−rⱼ=(αᵢ²λᵢ−αⱼ²λⱼ)S² (13b)

wherein relative high signal-to-noise ratio is assumed in relation (13a). Because the power of the transmitted pilot signal S² and the channel eigenvalues λᵢ are known at the receiver 203, αᵢ can be calculated in the receiver 203 using relations (8) and (13a) or (13b).

Further, because the quantized values qᵢ are used for all power loadings, the power ratio/difference in relations (13a) and (13b) should be fixed values from a finite set of numbers once a quantization table is defined. In such cases, the detection errors caused by noise/interference will be significantly decreased because the detection errors occur only when the noise with sufficient large power is present.

The following is a example power loading computation/detection procedure in the receiver 203, wherein a unit power pilot is assumed for simplicity:

(a) compute rᵢ for all i.

(b) starting with i=1,
compute

$${c}_{i} = \frac{{r}_{i}}{{\sum }_{j = i + 1}^{{N}_{t}} {r}_{j}} \qquad ( 14 a )$$
or

$${d}_{i} = {r}_{i} - {\sum }_{j = i + 1}^{{N}_{t}} {r}_{j} \qquad ( 14 b )$$

(c) find the nearest pair of quantization numbers corresponding to cᵢ or dᵢ

(d) for i=i+1, repeat steps (a) and (b) until i>Nₜ.

FIG. 4 shows a flowchart of the steps of an example implementation of the above power loading computation/detection procedure. The detection process involves: calculating and rank-ordering pilot signal power rᵢ (step 400); initiating index i as i=1:Nₜ (step 402); computing cᵢ according to relation (14a) or computing dᵢ according to relation (14b) (step 404); finding qᵢ corresponding to cᵢ or dᵢ (step 406); incrementing i by one (step 408); determining if i>Nₜ (step 410), and if so ending the process, otherwise proceeding to previous step 404.

Accordingly, utilizing quantization in the transmitter 201 to provide transmit power loading values, allows automatic detection of power loading values in the receiver 203. As a result, the transmitter 201 need not provide the receiver 203 with the power loading values, thereby increasing throughput of the system 200. The receiver 203 can detect the power loading values automatically based on the quantization values. In one example, relations (13a) and/or (13b), implemented as the process in FIG. 4, are used by the receiver 203 for power loading estimation and detection. At the transmitter 201, quantization is performed sequentially for the channels (i.e., quantization is performed for a first channel, and then a second channel, etc.). Preferably, quantization beings with the channel having the largest eigenvalue, as this is most efficient.

The present invention provides a practical way to meet the power sum constraint in implementing the optimal ‘water filling’ algorithm or any other uneven power loading algorithms for a communication system. By using the quantized values for the optimal power loading weights, the memory size for fixed length representation is reduced, i.e., the overhead size in the signaling field is reduced in notifying the receiver. Further, when automatic detection is performed, using quantized values can significantly decrease the detection errors of the power loading weights at the receiver.

The present invention has been described in considerable detail with reference to certain preferred versions thereof; however, other versions are possible. For example, instead of uniform step size quantization, an un-uniform quantization method can be used. In another example, instead of using automatic detection, the receiver may know the power loading weights through the signaling fields from the transmitter. Further, the pilot signal with known power is only one of the choices used for power loading estimation. Any reference signals with known power, such as pilot, training sequences, beacon, . . . , etc., can be used for estimation. Therefore, the spirit and scope of the appended claims should not be limited to the description of the preferred versions contained herein.

What is claimed is:

1. A telecommunication system, comprising:
a wireless transmitter that transmits data stream signals via multiple channels over a plurality of antennas, the transmitter including a power controller that selects transmission power loading per channel; and
a wireless receiver that receives data stream signals from the transmitter, wherein the receiver comprises a detector that automatically estimates power loading selections of the transmitter.

2. The system of claim 1 wherein the transmitter is a beamforming MIMO transmitter.

3. The system of claim 1 wherein the controller further selects transmission power loading for each channel based on channel condition.

4. The system of claim 1 wherein the controller further quantizes the power loading values.

5. The system of claim 4 wherein the detector uses the quantized power loading values to automatically estimate power loading selection by the transmitter.

6. The system of claim 5 wherein the controller selects the power loading values and further quantizes the power loading values under a power sum constraint.

7. The system of claim 5 wherein the transmitter transmits a reference signal with known power to the receiver, such that the detector estimates the transmit power loadings as a function of the power of the reference signal and the quantized power loadings.

8. The system of claim 1 wherein the controller provides uneven power loading among the multiple channels.

9. The system of claim 1 wherein the controller further allocates transmission power to the multiple channels based on channel eigenvalues to increase transmission rates of channels with low eigenvalues.

10. The system of claim 1 wherein the controller further selects lower power loading for channels with high eigenvalues, and selects higher power loading for channels with low eigenvalues.

11. The system of claim 1 wherein the receiver receives the transmitted data streams and demodulates the received data streams based on power loading selection of the transmitter.

12. The system of claim 11 wherein the telecommunication system comprises a close-loop MIMO system.

13. A closed-loop signaling method over multiple channels in a telecommunication system, comprising the steps of:
obtaining an information bit stream;
determining transmission power loading per channel according to channel condition;
transmitting the information bit stream via said multiple channels over a plurality of antennas of a transmitter according to the power loading per channel;
receiving the transmitted bits streams in a receiver; and
estimating that transmit power loading of the transmitter at the receiver.

14. The method of claim 13 wherein the transmitter comprises a beamforming MIMO transmitter.

15. The method of claim 13 wherein the step of determining power loading at the receiver further includes the steps of selecting transmission power loading for each channel based on channel condition.

16. The method of claim 13 wherein transmission power distribution over said multiple channels is essentially optimized for enhanced system throughput.

17. The method of claim 13 wherein the step of determining power loading in the transmitter further includes the steps of selecting uneven power loading among the multiple channels.

18. The method of claim 13 wherein the step of determining power loading at the transmitter further includes the steps of allocating transmission power to the multiple channels based on channel eigenvalues to increase transmission rates of channels with low eigenvalues values.

19. The method of claim 13 wherein the step of determining power loading at the transmitter further includes the steps of selecting lower power loading for channels with high eigenvalues, and selecting higher power loading for channels with low eigenvalues.

20. The method of claim 13 further including the steps of quantizing the power loading values in the transmitter.

21. The method of claim 20 further including the steps of using the quantized power loading values in the receiver to estimate power loading selection by the transmitter.

22. The method of claim 20 wherein selecting the power loading values further including the steps of selecting the power loading values and quantizing the power loading values under a power sum constraint.

23. The method of claim 20 further including the steps of the transmitter transmitting a reference signal with known power to the receiver, wherein the transmit power loadings are estimated in the receiver as a function of the power of the reference signal and the quantized power loadings.
